(19) United States
(12) Patent Application Publication
(10) Pub. No.: US 2022/0333410 A1
(43) Pub. Date: Oct. 20, 2022

(54) LOCKING MEMBERS

(71) Applicant: Hewlett-Packard Development Company, L.P., Spring, TX (US)

(72) Inventors: Hou-Chu Su, Taipei City (TW); Hsin-Yi Lee, Taipei City (TW); Wei-Ming Tseng, Taipei City (TW); Yu-Chen So, Taipei City (TW)

(21) Appl. No.: 17/233,902

(22) Filed: Apr. 19, 2021

(51) Int. Cl. E05B 73/00

(52) U.S. Cl. CPC E05B 73/0052; E05B 73/0082

(57) ABSTRACT

In some examples, an apparatus can include a first locking member, the first locking member including a column, a first magnet movably located in the first locking member, a second locking member rotatably connected to the column, and a second magnet located in the second locking member, where when the first magnet is in a disengaged position, the second locking member is rotatable about the column, and when the first magnet is translated from the disengaged position to an engaged position in the first locking member, a magnetic force is created between the first magnet and the second magnet to align the first locking member and the second locking member.

### BACKGROUND

Some users of computing devices may utilize their computing devices in different environments. Certain computing devices can be portable to allow a user to carry or otherwise bring with the computing device while in a mobile setting. A computing device can allow a user to utilize computing device operations for work, education, gaming, multimedia, and/or other general use in a mobile setting.

### BRIEF DESCRIPTION OF THE DRAWINGS

FIG. 1 is a perspective view of an example of an apparatus including locking members consistent with the disclosure.

FIG. 2 is a perspective view of an example of an apparatus including locking members being positioned with respect to a surface consistent with the disclosure.

FIG. 3A is a perspective view of an example of an apparatus including locking members with a magnet in a disengaged position and a key consistent with the disclosure.

FIG. 3B is a perspective view of an example of an apparatus including locking members with a magnet in an engaged position without a key consistent with the disclosure.

FIG. 3C is a perspective view of an example of an apparatus including locking members with a magnet in an engaged position and the locking members aligned consistent with the disclosure.

FIG. 4 is a side view of an example of an apparatus including locking members in a locked orientation and positioned with respect to a surface consistent with the disclosure.

FIG. 5A is a perspective view of an example of an apparatus including locking members having a magnet in a disengaged position with a key consistent with the disclosure.

FIG. 5B is another perspective view of the example of the apparatus of FIG. 5A including locking members having a magnet in an engaged position consistent with the disclosure.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an all-in-one (AIO) computer, among other types of computing devices.

Certain users may utilize computing devices in a mobile setting. For example, a user may utilize their computing device in a library, coffee shop, an airport, and/or any other mobile setting. In such mobile settings, a user may utilize a surface on which to set their computing device. For example, such a surface may be a work surface such as a desk, table, bench, etc. Utilizing the work surface can allow a user to more easily interact with and utilize the computing device as compared with holding the computing device or setting the computing device in the user's lap, etc.

In such mobile settings, a user may desire to move about in the mobile setting without packing up the computing device to bring with the user. For example, a user may be working in a coffee shop, airport, library, etc. while having their computing device on a surface (e.g., a table). The user may want to leave the table temporarily to, for instance, use the restroom, get a drink, make a telephone call, etc. Such an absence from the table may be of such a temporary time period that moving the computing device is not feasible, as setting up and/or taking down the computing device and/or booting up and/or powering down the computing device may take time.

However, in such an instance, a user may encounter uncertainty about leaving their computing device in such a location unattended. For example, such an unattended computing device may be easily stolen. Previous approaches to securing a computing device may include wrapping a cable around a table leg or creating any other closed loop and locking such cable with a locking mechanism. However, some work surfaces may not include structure to allow for locking a cable in a closed loop to secure a computing device to the work surface.

Locking members according to the disclosure can allow for an apparatus connected to the computing device to compressibly engage a surface. The apparatus can engage the surface, such as a desk, table, etc. in order to secure the apparatus to the surface. As the apparatus can be connected to the computing device, the apparatus can, accordingly, secure the computing device to the surface, which can prevent the computing device from being easily stolen, as is further described herein.

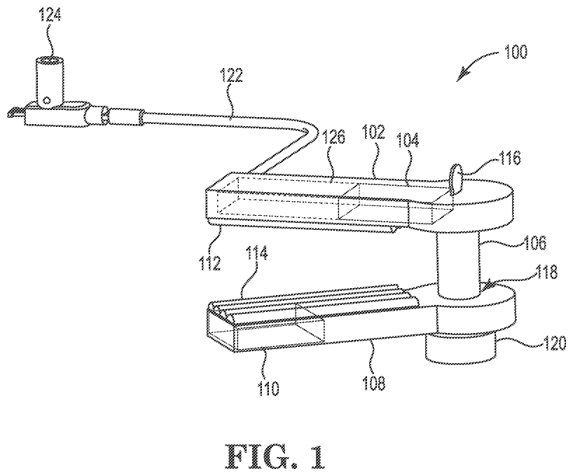

FIG. 1 is a perspective view of an example of an apparatus 100 including locking members consistent with the disclosure. As illustrated in FIG. 1, the apparatus 100 can include a first locking member 102 and a second locking member 108.

The first locking member 102 and the second locking member 108 can secure the apparatus 100 to a surface, as is further described herein. As used herein, the term “member” refers to a constituent component of a composite whole. For example, the first locking member 102 and the second locking member 108 can be utilized to compressibly engage with a surface such that the apparatus 100 is in a locked orientation to secure a computing device to the surface.

The first locking member 102 can include a column 106. As used herein, the term “column” refers to a rigid support. The column 106 can be a support structure for the second locking member 108, as is further described herein. In some examples, the column 106 can be connected to the first locking member 102. In some examples, the column 106 can be of a same structure as the first locking member 102.

The first locking member 102 can further include a channel 126. As used herein, the term “channel” refers to a passage within an object. The channel 126 can allow for an object within the first locking member 102 to linearly translate within the channel 126 within the first locking member 102, as is further described herein.

The first locking member 102 can include a first gripping surface 112. As used herein, the term “gripping surface” refers to an area of a surface having properties so as to provide a force to resist motion of another surface sliding against the area of the surface. For example, the first gripping surface 112 can be a surface on the first locking member 102 which, when compressed against another surface, can provide frictional resistance against movement relative to the another surface. The first gripping surface 112 can be, for example, a material such as rubber and/or any other material having a sufficiently high coefficient of friction to resist motion of another surface sliding against the first gripping surface 112.

As illustrated in FIG. 1, the first locking member 102 can further include a first magnet 104. As used herein, the term “magnet” refers to an object of a material that produces a magnetic field. The first magnet 104 can be movably located in the channel 126 of the first locking member 102 and can translate within the channel 126 under certain conditions, as is further described herein.

The apparatus 100 can further include a second locking member 108. As mentioned above, the second locking member 108, when used in conjunction with the first locking member 102, can engage with a surface such that the apparatus 100 is in a locked orientation to secure a computing device to the surface. When the apparatus 100 is in the locked orientation, the first locking member 102 and the second locking member 108 cannot move relative to the surface.

An aperture 118 can be included as part of the second locking member 108. As used herein, the term “aperture” refers to an opening through an object. For example, the second locking member 108 can include the aperture 118 which can be of a dimension to receive the column 106 of the first locking member 102. That is, the second locking member 108 can be rotatably connected to the column 106 via the aperture 118. Such an aperture 118 can allow the second locking member 108 to be rotatable about the column 106 and vertically translatable about the column 106, relative to the first locking member 102.

Similar to the first locking member 102, the second locking member 108 can include a second gripping surface 114. The second gripping surface 114 can be of a same or similar material as the first gripping surface 112. The second gripping surface 114 can be, for example, a material such as rubber and/or any other material having a sufficient coefficient of friction to resist motion of another surface sliding against the second gripping surface 114.

As illustrated in FIG. 1, the column 106 can include a flange 120. As used herein, the term “flange” refers to an external or internal ridge or rim of material to provide a location for attachment or placement of another object. For instance, as illustrated in FIG. 1, the second locking member 108 can be adjacent to or resting on the flange 120 when the first magnet 104 is in the disengaged position. As such, the flange may retain the second locking member 108 on the column 106. In such an example, the apparatus 100 can be in an unlocked orientation, as is further described herein.

Similar to the first locking member 102, the second locking member 108 can include a second magnet 110. The second magnet 110 can be located in and fixed within the second locking member 108. The second magnet 110 can be fixed in the second locking member 108 such that the second magnet 110 does not move (e.g., does not translate, rotate, etc.) relative to the second locking member 108.

The apparatus 100 can include a lock cable 122. As used herein, the term “lock cable” refers to a material to form a rope. The lock cable 122 can, for example, consist of strands of metal wire or other material that may be twisted or braided together with a protective outer cover. Such a lock cable 122 can be of a material that can resist cutting, shearing, compressive, and/or tensile forces that can help to prevent theft of a computing device when the apparatus 100 is in a locked orientation.

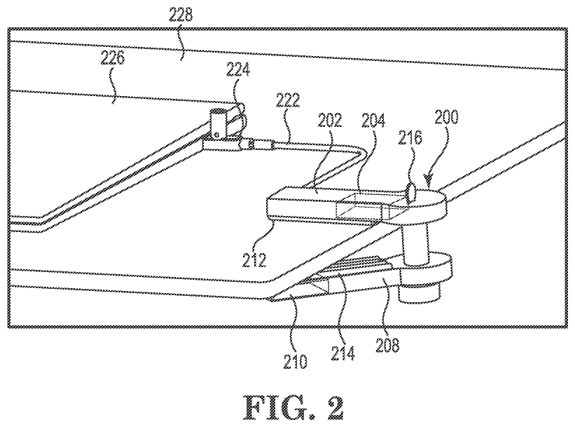

The lock cable 122 can be connected to a locking mechanism 124. As used herein, the term “locking mechanism” refers to a device to secure an object in a particular position. For example, the locking mechanism 124 can be connected to a computing device (e.g., not illustrated in FIG. 1) to secure the computing device on a surface (e.g., a work surface) in conjunction with the lock cable 122 and the apparatus 100, as is further described in connection with FIG. 2. In some examples, the locking mechanism 124 can be, for instance, a Kensington lock to interface with a Kensington Security Slot on the computing device. However, examples of the disclosure are not so limited. For example, the locking mechanism 124 can be a padlock or any other type of lock or locking mechanism.

As illustrated in FIG. 1, the first magnet 104 can be in the disengaged position. As used herein, the term “disengaged position” refers to an orientation of a first magnet in a first locking member in which a magnetic force is not sufficiently present to cause an attractive force between the first magnet and a second magnet in a second locking member to cause the second locking member to rotatably and vertically align with the first locking member. For example, when the first magnet 104 is in the disengaged position as illustrated in FIG. 1, the second locking member 108 is rotatable about the column 106. In such an instance, the apparatus 100 can be in an unlocked orientation. As used herein, the term “unlocked orientation” refers to a position in which a first locking member and a second locking member are not aligned and/or magnetically attracted to one another so as to compressibly engage another surface. Accordingly, when the apparatus 100 is in the unlocked orientation, the second locking member 108 can be vertically translatable relative to the first locking member 102 and rotatable about the column 106.

The apparatus 100 can further include a key 116. As used herein, the term “key” refers to a device to cause a magnet to translate in order to cause the apparatus 100 to be in a locked orientation or an unlocked orientation. As a result of the key 116 being present, the first magnet 104 can be in the disengaged position. For example, although not illustrated in FIG. 1, the key 116 can be attached to a mechanism inside of the first locking member 102 to cause translation of the first magnet 104 when the key 116 is actuated (e.g., turned). Such translation of the first magnet 104 can be from an engaged position to the disengaged position or from the disengaged position to an engaged position, as is further described herein.

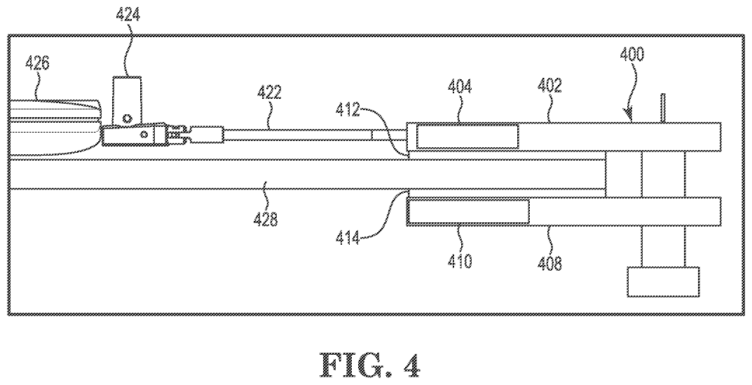

When the key 116 is actuated, the first magnet 104 can translate in the channel 126 from the disengaged position to an engaged position. As used herein, the term “engaged position” refers to an orientation of a first magnet in a first locking member in which a magnetic force is sufficiently present to cause an attractive force between the first magnet and a second magnet in a second locking member to cause the second locking member to rotatably and vertically align with the first locking member. That is, a magnetic force can be created between the first magnet 104 and the second magnet 110 to cause the second locking member 108 to rotatably and vertically align with the first locking member 102 such that the apparatus 100 is in a locked orientation. As used herein, the term “locked orientation” refers to a position in which a first locking member and a second locking member are compressibly engaging another surface due to such magnetic attraction between the first and second magnets 104 and 110. In the locked orientation, the apparatus 100 can compressibly engage a surface, such as a desk, table, bench, etc., as is further described in connection with FIG. 4.

Although not illustrated in FIG. 1, in some examples the first magnet 104 can be in contact with a rolling mechanism. The rolling mechanism can assist the first magnet 104 to translate within the channel 126. The rolling mechanism can include, for example, bearings, circular rods, etc. upon which the first magnet 104 can translate.

While the first magnet 104 is described above as being in contact with a rolling mechanism to assist the first magnet 104 to translate within the channel 126, examples of the disclosure are not so limited. For example, the first magnet 104 can be in contact with a linkage, cams, and/or any other translational mechanism to assist the first magnet 104 to translate within the channel 126.

FIG. 2 is a perspective view of an example of an apparatus 200 including locking members 202, 208 being positioned with respect to a surface 228 consistent with the disclosure. As illustrated in FIG. 2, the apparatus 200 can include a first locking member 202 and a second locking member 208.

As illustrated in FIG. 2, the apparatus 200 can be in an unlocked orientation. The lock cable 222 can be connected to the locking mechanism 224 which can be connected to a computing device 226.

A user of the computing device 226 may be utilizing the computing device 226 in a mobile setting while using the surface 228 (e.g., a table). For example, the user may rest the computing device 226 on the surface 228, and the surface 228 may support the computing device 226 while resting on the surface 228. The user may desire to briefly leave the computing device 226 unattended. Accordingly, the user can position the apparatus 200 (e.g., when the user begins to utilize the surface 228, when the user desires to leave the computing device 226 unattended, etc.) as oriented in FIG. 2. For instance, the user can position the surface 228 between the first locking member 202 and the second locking member 208.

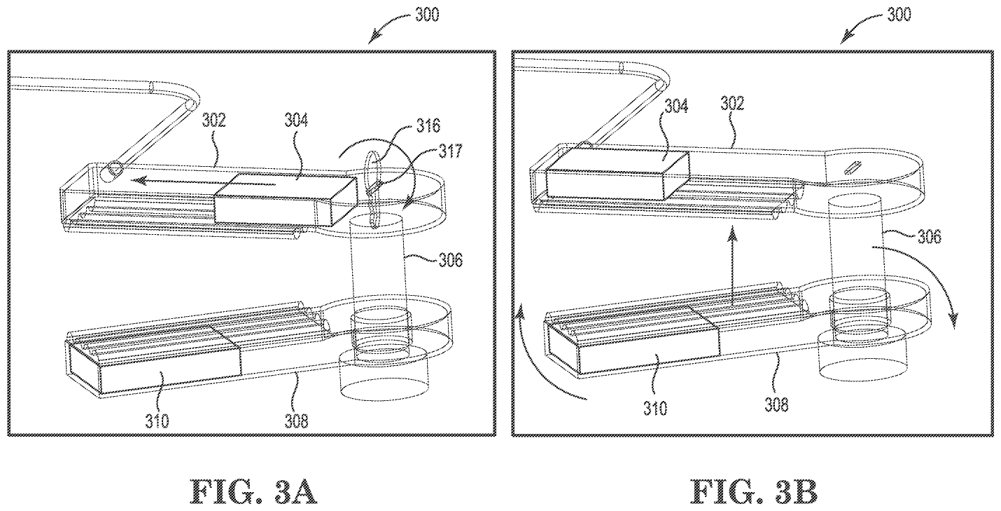

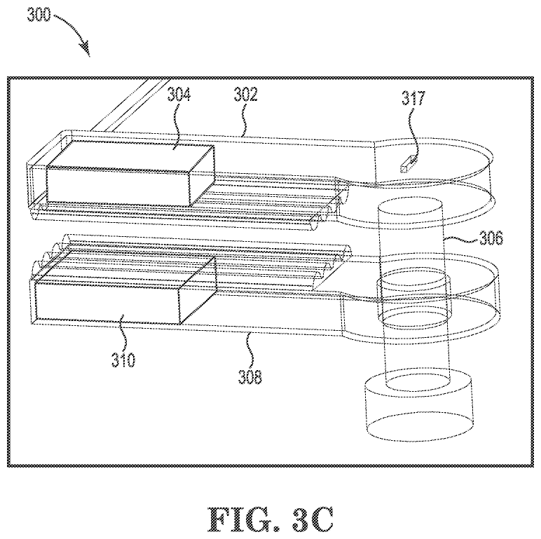

As the apparatus 200 is in the unlocked orientation, the first magnet 204 can be in a disengaged position. When a user actuates the key 216, the first magnet 204 can translate in a channel in the first locking member 202 to an engaged position. When the first magnet 204 is in the engaged position, a magnetic force between the first magnet 204 and the second magnet 210 can cause the second locking member 208 to rotate and vertically translate towards the first locking member 202. Accordingly, the first locking member 202 and the second locking member 208 can engage the surface 228, where a first gripping surface 212 and a second gripping surface 214 can resist motion of the apparatus 200 relative to the surface 228. Such an approach is further described in connection with FIGS. 3A-3C.

FIG. 3A is a perspective view of an example of an apparatus 300 including locking members 302, 308 with a magnet 304 in a disengaged position and a key 316 consistent with the disclosure. As illustrated in FIG. 3, the apparatus 300 can include a first locking member 302 and a second locking member 308.

The first locking member 302 can include a first magnet 304 in a disengaged position. For example, in the presence of the key 316, the first magnet 304 can be in the disengaged position such that the apparatus 300 is in an unlocked orientation.

The second locking member 308 can include a second magnet 310. In the unlocked orientation, the second locking member 308 can be vertically translatable with respect to the first locking member 302 and further rotatable about a column 306.

In some examples, the first locking member 302 can include a keyway 317. As used herein, the term “keyway” refers to a slot in a part of a component that can receive a key. For example, the keyway 317 can receive the key 316 such that when the key 316 is present (e.g., and/or actuated), the first magnet 304 can be in the disengaged position as illustrated in FIG. 3A.

When the key 316 is actuated and/or removed, a mechanism can cause the first magnet 304 to translate in the first locking member 302 from the disengaged position to the engaged position (e.g., as illustrated in FIG. 3B). Such translation can cause the apparatus 300 to move from the unlocked orientation (e.g., as illustrated in FIG. 3A) to the locked orientation (e.g., as illustrated in FIG. 3C). For example, when a user wishes to secure a computing device attached to the apparatus 300 to a surface, the user can place the apparatus 300 such that the surface is positioned between the first locking member 302 and the second locking member 308 and actuate and/or remove the key 316.

As described above, when the key 316 is inserted and actuated, the mechanism can cause the first magnet 304 to translate in the first locking member 302 from the disengaged position to the engaged position. However, examples of the disclosure are not so limited. For example, in some instances, when the key 316 is actuated and removed from the keyway 317, the mechanism can cause the first magnet 304 to translate in the first locking member 302 from the engaged position to the disengaged position.

FIG. 3B is a perspective view of an example of an apparatus 300 including locking members 302, 308 with a magnet 304 in an engaged position without a key consistent with the disclosure.

When the key is actuated and/or removed, the first magnet 304 is to translate from the disengaged position to the engaged position. When the first magnet is in the engaged position, a magnetic force can be created between the first magnet 304 and the second magnet 310. Such a magnetic force can be an attractive force between the first magnet 304 and the second magnet 310 which can cause the second locking member 308 to rotate about the column 306 to align with the first locking member 302. Additionally, the magnetic force can cause the second locking member 308 to vertically align (e.g., move upwards, as oriented in FIG. 3B) with the first locking member 302. In other words, the magnetic force can cause the second locking member 308 to rotate about the column 306 and vertically translate towards the first locking member 302. Accordingly, the first locking member 302 and the second locking member 308 can engage a surface located between the first locking member 302 and the second locking member 308, as is further illustrated and described in connection with FIG. 4.

FIG. 3C is a perspective view of an example of an apparatus 300 including locking members 302, 308 with a magnet 304 in an engaged position and the locking members 302, 308 aligned consistent with the disclosure.

In response to the second locking member 308 rotating and vertically translating towards the first locking member 302, the first locking member 302 and the second locking member 308 can engage a surface located between the first locking member 302 and the second locking member 308. Accordingly, the apparatus 300 can be in a locked orientation where the second locking member 308 is rotatably and vertically aligned with the first locking member 302.

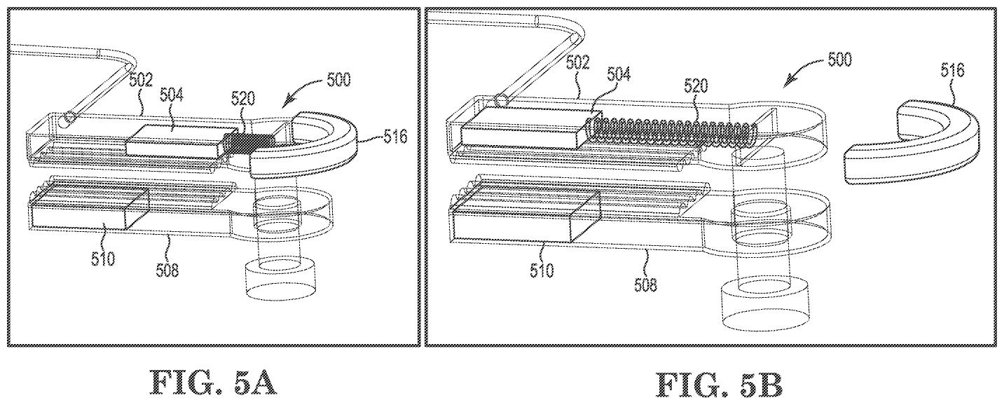

In an instance in which the user wishes to disengage the surface located between the first locking member 302 and the second locking member 308, the user can reintroduce a key to the apparatus 300. For example, a key can be inserted into the keyway 317 and/or be otherwise connected to the first locking member 302 (e.g., as is further described in connection with FIGS. 5A and 5B. In response to the key being present, a mechanism can cause the first magnet 304 to translate in the first locking member 302 (e.g., within a channel in the first locking member 302) from the engaged position to the disengaged position (e.g., as previously illustrated in FIG. 3A). When the first magnet 304 is in the disengaged position, the apparatus 300 can move from the locked orientation to the unlocked orientation. That is, the second locking member 308 can vertically translate away from the first locking member 302 and can be rotatable about the column 306.

FIG. 4 is a side view of an example of an apparatus 400 including locking members in a locked orientation and positioned with respect to a surface 428 consistent with the disclosure. The apparatus 400 can include a first locking member 402 and a second locking member 408.

As illustrated in FIG. 4, the apparatus 400 can be in the locked orientation. That is, a first magnet 404 can be in the engaged position such that a magnetic force between the first magnet 404 and a second magnet 410 can cause the second locking member 408 to be rotatably and vertically aligned with the first locking member 402.

In the locked orientation, the first locking member 402 and the second locking member 408 can compressibly engage the surface 428. For example, the surface 428 can be located between the first locking member 402 and the second locking member 408. Additionally, the first gripping surface 412 and the second gripping surface 414 can interact with (e.g., grip) the surface 428. For instance, a first gripping surface 412 and a second gripping surface 414 can compressibly engage the surface 428 in order to resist lateral and/or rotational motion of the apparatus 400 with respect to the surface 428.

As illustrated in FIG. 4, the apparatus 400 can include the lock cable 422 connected to the locking mechanism 424. The locking mechanism 424 can be connected to the computing device 426. As the first locking member 402 and the second locking member 408 engage the surface 428 while in the locked orientation, the apparatus 400 can secure the computing device 426 to the surface 428.

FIG. 5A is a perspective view of an example of an apparatus 500 including locking members 502, 508 having a magnet 504 in a disengaged position with a key 516 consistent with the disclosure. The apparatus 500 can include a first locking member 502 and a second locking member 508.

As previously described in connection with FIGS. 1, 2, and 3A, a key can be a device receivable by a keyway included in the first locking member. However, examples of the disclosure are not so limited. For example, the key 516 can be a third magnet as illustrated in FIG. 5A.

For instance, when the key 516 is a third magnet, another magnetic force can be created between the key 516 and the first magnet 504. Such a magnetic force can have a magnitude that is greater than a spring force generated by a spring mechanism to cause the first magnet 504 to translate in a channel of the first locking member 502 from an engaged position (e.g., as is further described in connection with FIG. 5B) to the disengaged position. For example, if the first magnet 504 is in the engaged position (e.g., as illustrated in FIG. 5B), the magnetic force created between the first magnet 504 and the key 516 can cause the first magnet 504 to translate in the first locking member 502 from the engaged position to the disengaged position so that no (or negligible) magnetic force exists between the first magnet 504 and the second magnet 510. As illustrated in FIG. 5A, the first magnet 504 can be connected to a mechanism 520, as is further described in connection with FIG. 5B.

The key 516, as the third magnet, can be shaped as a half-circle. For example, the shape of the half-circle can allow for generation of a sufficient magnetic force to cause the first magnet 504 to be in the disengaged position. Additionally, while the third magnet is illustrated as being shaped as a half-circle, examples of the disclosure are not so limited. For instance, the third magnet can be any other shape.

FIG. 5B is another perspective view of the example of the apparatus 500 of FIG. 5A including locking members 502, 508 having a magnet 504 in an engaged position consistent with the disclosure.

When the key 516 is removed from the first locking member 502, the first magnet 504 is to translate in the channel from the disengaged position to the engaged position. For example, when the key 516 is moved a sufficient distance from the first magnet 504, the mechanism 520 can cause the first magnet 504 to translate to the engaged position in the first locking member 502. The sufficient distance can be, for instance, a distance at which the magnetic attraction force between the first magnet 504 and the key 516 is less than a force supplied by the mechanism 520 on the first magnet 504 (e.g., a spring force, as is further described herein).

The mechanism 520 can, for example, be a spring mechanism. As used herein, the term “spring mechanism” refers to a mechanical device that stores energy. For example, when the first magnet 504 is in the disengaged position (e.g., as illustrated in FIG. 5A), the spring mechanism 520 can be in a compressed state storing potential energy as a result of the presence of the key 516. In the absence of the key 516, the spring mechanism 520 can move from the compressed state to a resting state, where the spring mechanism 520 causes the first magnet 504 to translate to the engaged position. At the engaged position of the first magnet 504, the apparatus 500 can move from the unlocked orientation to the locked orientation in order to secure a computing device to a surface.

Locking members according to the disclosure can allow for a computing device to be secured to a surface by an apparatus. Such an apparatus can prevent the computing device from being easily removed (e.g., stolen or otherwise) from the surface, especially in an instance in which the computing device may be unattended by a user.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a first locking member, the first locking member including a column;
a first magnet movably located in the first locking member;
a second locking member rotatably connected to the column; and
a second magnet located in the second locking member;
wherein:
when the first magnet is in a disengaged position, the second locking member is rotatable about the column; and
when the first magnet is translated from the disengaged position to an engaged position in the first locking member, a magnetic force is created between the first magnet and the second magnet to align the first locking member and the second locking member.

2. The apparatus of claim 1, wherein the magnetic force is to cause the second locking member to rotate and vertically translate towards the first locking member.

3. The apparatus of claim 2, wherein in response to the second locking member rotating and vertically translating towards the first locking member, the first locking member and the second locking member are to engage a surface located between the first locking member and the second locking member.

4. The apparatus of claim 3, wherein:
the first locking member includes a first gripping surface and the second locking member includes a second gripping surface; and
the first gripping surface and the second gripping surface are to compressibly engage the surface.

5. The apparatus of claim 1, wherein:
the first locking member includes a channel; and
the first magnet is located in the channel.

6. The apparatus of claim 1, wherein the second locking member includes an aperture and is rotatably connected to the column via the aperture.

7. The apparatus of claim 1, wherein the column includes a flange such that the second locking member is adjacent to the flange when the first magnet is in the disengaged position.

8. An apparatus, comprising:
a first locking member, the first locking member including a column and a channel;
a first magnet located in the channel;
a second locking member rotatably connected to the column;
a second magnet located in the second locking member; and
a lock cable connected to a locking mechanism to connect to a computing device;
wherein:
when the first magnet is in a disengaged position, the second locking member is rotatable about the column such that the apparatus is in an unlocked orientation; and
when the first magnet is translated in the channel from the disengaged position to an engaged position, a magnetic force is created between the first magnet and the second magnet to cause the second locking member to rotatably and vertically align with the first locking member such that the apparatus is in a locked orientation.

9. The apparatus of claim 8, wherein the apparatus further includes a key.

10. The apparatus of claim 9, wherein the key is to cause the first magnet to translate in the channel from the engaged position to the disengaged position such that the apparatus moves from the locked orientation to the unlocked orientation.

11. The apparatus of claim 10, wherein when the first magnet is in the engaged position, the magnetic force between the first magnet and the second magnet is to cause the second locking member to rotatably and vertically align with the first locking member to engage a surface located between the first locking member and the second locking member such that the first locking member and the second locking member cannot move relative to the surface.

12. An apparatus, comprising:
a first locking member, the first locking member including a column and a channel;
a first magnet located in the channel;
a second locking member including an aperture, wherein the second locking member is rotatably connected to the column via the aperture; and
a second magnet fixed in the second locking member;
wherein:
in response to the presence of a key, the first magnet is to be in a disengaged position such that the apparatus is in an unlocked orientation where the second locking member is vertically translatable and rotatable about the column; and
in response to the absence of the key, the first magnet is to translate in the channel from the disengaged position to an engaged position to create a magnetic force between the first magnet and the second magnet such that the apparatus is in a locked orientation where the second locking member is rotatably and vertically aligned with the first locking member.

13. The apparatus of claim 12, wherein the first locking member includes a keyway to receive the key.

14. The apparatus of claim 13, wherein in response to the keyway receiving the key, a spring mechanism generates a spring force to cause the first magnet to translate in the channel from the disengaged position to the engaged position.

15. The apparatus of claim 14, wherein the key is a third magnet such that in the presence of the third magnet, another magnetic force is created between the third magnet and the first magnet that is greater in magnitude than the spring force to cause the first magnet to translate in the channel from the engaged position to the disengaged position.
